(19) United States
(12) Patent Application Publication
(10) Pub. No.: US 2017/0264164 A1
(43) Pub. Date: Sep. 14, 2017

(54) Device and Method for Storing Energy

(71) Applicant: Siemens Aktiengesellschaft, Muenchen (DE)

(72) Inventors: Uwe Lenk, Zwickau (DE); Alexander Tremel, Moehrendorf (DE)

(73) Assignee: Siemens Aktiengesellschaft, Muenchen (DE)

(21) Appl. No.: 15/515,236

(22) PCT Filed: Sep. 17, 2015
(86) PCT No.: PCT/EP2015/071292

§ 371 Date: May 24, 2017

(30) Foreign Application Priority Data
Sep. 29, 2014 (DE) 10 2014 219 678.7

(51) Int. Cl. H02K 7/18; F03G 7/06; F03G 7/04; F03B 17/00

(52) U.S. Cl. CPC H02K 7/1823; F03B 17/005; F03G 7/06; F03G 7/04

(57) ABSTRACT

The present disclosure relates to energy storage. The teachings thereof may be embodied in a device and/or a method for storing electricity. For example a device for storing energy may include: a first vessel having a first holding space; a separating apparatus dividing the first holding space into a first chamber for holding a first medium and a second chamber for holding a gas phase; the separating apparatus movable to cause a simultaneous change in volume of the first chamber and the second chamber; a second vessel with a second holding space exchanging mass transfer of the gas phase in the second chamber; a temperature-control apparatus supplying or removing heat energy to the second vessel; a conveying apparatus conveying the medium into the first chamber; and an expansion apparatus driven by the medium.

### CROSS-REFERENCE TO RELATED APPLICATIONS

This application is a U.S. National Stage Application of International Application No. PCT/EP2015/071292 filed Sep. 17, 2015, which designates the United States of America, and claims priority to DE Application No. 10 2014 219 678.7 filed Sep. 29, 2014, the contents of which are hereby incorporated by reference in their entirety.

### TECHNICAL FIELD

The present disclosure relates to energy storage. The teachings thereof may be embodied in a device and/or a method for storing energy, in particular electricity.

### BACKGROUND

The storage of electricity by batteries is usually limited to a power range of less than a few megawatts. The potential power range is limited by the overall size of batteries, but is also dependent on the specific investment costs which may be very high. In the high power range, the storage of electricity may include pumped-storage power plants and so-called power-to-gas applications. However, pumped-storage power plants are limited in their application by geographical and ecological constraints. In addition, a major investment requirement is necessary for erecting them. The power-to-gas technology is suitable for long-term storage, but has not yet reached an adequate development maturity. Furthermore, pressurized-air-storage power plants are being developed which can likewise be used in a high power range. Such pressurized-air-storage power plants are likewise subject to geographical constraints, however, and only have an average degree of electricity storage efficiency. Furthermore, such pressurized-air-storage power plants have also not yet reached an adequate development maturity.

DE 10 2004 047 290 A1 discloses aspects of energy conversion for the purposes of very short-term energy storage. The teachings therein include conveying liquid water at elevated pressure from an electrically operated pressure build-up device into a water reservoir, in order thereby to drive a water turbine. The water pressure in the water reservoir is buffered by a connected gas-pressure accumulator which is charged with air or nitrogen, for example. In the water turbine, the pressure drop in the liquid water takes place and, following temporary storage, this liquid water flows away back into the pressure build-up device.

A disadvantage of this device is that, in order to build up an elevated pressure in liquid water, a very complex pressure build-up device has to be available. In addition, a water turbine has only a low degree of efficiency, so that the temporary storage of energy experiences significant losses. Furthermore, the device described in DE 10 2004 047 290 A1 serves solely to temporarily store energy very briefly, since any form of energy input is transferred to the pressure-increasing process for liquid water, which process, however, has a pneumatic limitation.

### SUMMARY

The teachings of the present disclosure may provide a device and a method by means of which energy, in particular in the form of electrical energy, can be stored in a particularly effective and efficient manner.

For example, a device (10) for storing energy may include: at least one first vessel (12) having a first holding space (14), a separating apparatus (16) arranged in the first vessel (12), by means of which apparatus the first holding space (14) is divided into a first chamber (20) for holding a first medium and a second chamber (22) for holding a gas phase, the separating apparatus (16) being able to be moved relative to the first vessel (12) with a simultaneous change in volume of the chambers (20, 22), at least one second vessel (24), which has a second holding space (26) connected to the second chamber (22), the content (30) of which space undergoes mass transfer with the gas phase, a temperature-control apparatus (32), by means of which heat energy can be supplied to the second vessel (24) and removed from the second vessel (24), at least one conveying apparatus (36), by means of which the medium can be conveyed at a specifiable pressure into the first chamber (20) with a simultaneous removal of heat from the second vessel (24) effected by means of the temperature-control apparatus (32), and at least one expansion apparatus (46), which can be driven by the medium held under pressure in the first chamber (20) with a simultaneous supply of heat to the second vessel (24) effected by means of the temperature-control apparatus (32).

In some embodiments, a heat transfer device (58) arranged upstream of the first chamber (20) is provided for effecting a heat transfer between the medium and the content (30) of the second vessel (24).

In some embodiments, the medium is a liquid, in particular water, or a gas, in particular air.

In some embodiments, the content (30) of the second vessel (24) is a liquid or a solid.

In some embodiments, the conveying apparatus (36) comprises at least one compressor (60, 62) for compressing the medium.

In some embodiments, at least one heat accumulator (66) is provided, in which heat from the medium heated by means of the compression can be stored.

In some embodiments, a generator (54) which can be driven by the expansion apparatus (46) is provided, by means of which generator electrical energy can be provided by driving the generator (54).

Some embodiments may include a method for storing energy by means of a device (10), comprising: at least one first vessel (12) having a first holding space (14), a separating apparatus (16) arranged in the first vessel (12), by means of which apparatus the first holding space (14) is divided into a first chamber (20)for holding a first medium and a second chamber (22) for holding a gas phase, the separating apparatus (16) being able to be moved relative to the first vessel (12) with a simultaneous change in volume of the chambers (20, 22), at least one second vessel (24), which has a second holding space (26) connected to the second chamber (22), the content (30) of which space undergoes mass transfer with the gas phase, a temperature-control apparatus (32), by means of which heat energy can be supplied to the second vessel (24) and removed from the second vessel (24), at least one conveying apparatus (36), by means of which the medium is conveyed at a specifiable pressure into the first chamber (20), a removal of heat from the second vessel (24) being simultaneously effected by means of the temperature-control apparatus (32), and at least one expansion apparatus (46), which is driven by the medium held under pressure in the first chamber (20), a supply of heat to the second vessel (24) being simultaneously effected by means of the temperature-control apparatus (32).

In some embodiments, the supply of heat to the second vessel (24) is carried out at a temperature of less than 200 degrees Celsius, or at less than 140 degrees Celsius or at less than 100 degrees Celsius.

In some embodiments, during the supply of heat, heat is transferred from a further medium into the second vessel (24) via the temperature-control apparatus (32), the further medium having a temperature of less than 200 degrees Celsius, or less than 140 degrees Celsius or less than 100 degrees Celsius.

In some embodiments, during the supply of heat, the heat is provided by a power plant, an industrial process or a natural heat source.

In some embodiments, the medium is provided directly from a power plant or an industrial process and supplied back to there again.

### BRIEF DESCRIPTION OF THE DRAWINGS

Further features and details of the teachings emerge from the following description of exemplary embodiments and with reference to the drawings. The features and combinations of features mentioned above and the features and combinations of features mentioned below in the description of the figures and/or shown below in the figures alone may be used not only in the respectively specified combination, but also in other combinations or on their own, without departing from the scope of the teachings herein.

In the drawings:

FIG. 1 shows a diagrammatic illustration of a device according to an example embodiment for storing energy in the form of electrical energy, comprising two vessels, a separating apparatus arranged in the first of the vessels, a temperature-control apparatus, a conveying apparatus and an expansion apparatus;

FIG. 2 shows a diagrammatic illustration of the device according to another example embodiment; and

FIG. 3 shows a diagrammatic illustration of the device according to another example embodiment.

In the figures, identical or functionally identical elements are provided with the same reference signs.

### DETAILED DESCRIPTION

Various teachings of the present disclosure may be embodied in a device for storing energy, in particular electricity, having at least one first vessel which has a first holding space. The device further comprises a separating apparatus arranged in the first vessel, by means of which apparatus the first holding space is divided into a first chamber for holding a first medium and a second chamber for holding a gas phase. Here the separating apparatus is able be moved relative to the first vessel with a simultaneous change in volume of the chambers. In other words, if the separating apparatus in the first vessel moves relative thereto, this is accompanied by a simultaneous change in volume of the chambers. In this case, the change in volume of the first chamber is reciprocal to the change in volume of the second chamber. This means that when moving the separating apparatus, a decrease in volume of the first chamber is accompanied by an increase in volume of the second chamber, and vice versa. Here, the volumes of the chambers change to the same degree. This means that, for example, the volume of the first chamber decreases to the same degree as that to which the volume of the second chamber increases, and vice versa.

In some embodiments, the device furthermore comprises at least one second vessel, which has a second holding space connected to the second chamber, the content of which space undergoes mass transfer, in particular in thermodynamic equilibrium, with the gas phase. Moreover, the device comprises a temperature-control apparatus, by means of which heat or heat energy can be supplied to the second vessel and removed from the second vessel.

In some embodiments, the device further comprises at least one conveying apparatus, by means of which the medium can be conveyed at a specifiable pressure into the first chamber with a simultaneous removal of heat from the second vessel effected by means of the temperature-control apparatus. In other words, the medium is conveyed at a specifiable pressure into the first chamber by means of the conveying apparatus, heat being simultaneously removed from the second vessel, and in particular from the content thereof, by means of the temperature-control apparatus.

In some embodiments, the device comprises at least one expansion apparatus, which can be driven by the medium held under pressure in the first chamber with a simultaneous supply of heat to the second vessel effected by means of the temperature-control apparatus. In other words, the medium held or stored under pressure in the first vessel, in particular the first chamber, is removed from the first chamber and guided to the expansion apparatus, which apparatus is driven by means of the medium, heat or heat energy being simultaneously supplied to the second vessel, and in particular the content thereof, by means of the temperature-control apparatus.

Using the device, it is possible to store or temporarily store or accumulate in a particularly efficient and effective manner energy expended to drive the conveying apparatus and thus to convey the medium into the first chamber, in particular in at least one other form of energy, since the conveying apparatus conveys against a counter-pressure in the first vessel that is at least substantially constant. Consequently, it is possible to realize a design that has at least a high degree of efficiency. The energy for driving the conveying apparatus may be mechanical or electrical energy or electricity, which can be stored or temporarily stored in a particularly efficient and effective manner by means of the device.

The temporarily stored energy can also be released, that is to say removed from the device, in a particularly effective and efficient manner. For this purpose, the expansion apparatus is driven by means of the medium such that, for example, energy, in particular in the form of mechanical energy, can be provided and used by the expansion apparatus as a result of said apparatus being driven. Due to the supply of heat that is carried out while the expansion apparatus is being driven and thus while the energy is being released, it is possible to realize a high pressure in both vessels. As a consequence of this supply of heat and because of the particularly high pressure that results during the release, it is even possible—as has been found—for more energy, in particular electrical energy, to be released than was previously accumulated, if the supplied heat energy is not taken into consideration.

To keep the energy input for conveying the medium and thus for filling the first chamber particularly low, a heat transfer device arranged upstream of the first chamber is provided for effecting a heat transfer between the medium and the content of the second vessel. Consequently, a particularly effective and efficient storage of energy can be realized. In some embodiments, cold water or a cold liquid is used as the medium. By using the heat transfer device, it is possible to keep the temperature of the content of the second vessel low, so that the energy input for conveying the medium into the first chamber can also be kept low.

In some embodiments, the medium is a liquid, in particular water, or a gas, in particular air. By using a liquid, or water, or a gas, or air, it is possible for the energy to be stored in a particularly efficient and effective manner by means of the device.

In some embodiments, the content of the second vessel is a liquid or a solid. The liquid held in the second vessel can be the same substance or the same substance mixture as the gas phase in the second chamber. A thermodynamic phase equilibrium in the two-phase region, for example, is then present here. Furthermore, it is also possible for there to be a solution equilibrium between a liquid as the content and the gas phase, or for there to be a chemical reaction in equilibrium between the two. A first example for such an equilibrium is for example the phase equilibrium between a gaseous phase, that is to say the gas phase in the second chamber, and a liquid phase in the second vessel, ammonia or a refrigerant, for example, being used as a pure substance in the two-phase region. A second example for an equilibrium is a solution equilibrium between a gas phase and a liquid, for example a solution of carbon dioxide (CO₂) or ammonia in water. A third example for an equilibrium is a chemical equilibrium between a gas phase and a solid. This can for example be a reversible reaction between copper carbonate (CuCO₃) and copper oxide (CuO). Said reversible reaction is represented below:

CuO+CO₂<->CuCO₃

Internal fittings, for example a stirrer, by means of which, for example, the liquid as the content is stirred, are intended to ensure an active transfer, that is to say a mass transfer, between the content or the liquid and the gas phase.

In some embodiments, the conveying apparatus comprises at least one compressor for compressing the medium that is in particular formed as a gas, in particular air. This enables energy to be stored in a particularly efficient, quick and effective manner.

In some embodiments, to realize a particularly efficient accumulation and release of energy, at least one heat accumulator is provided, in which heat from the medium heated by means of the compression can be stored. If the medium is, for example, a gas, for example air, the air is heated by compression that is affected by means of the compressor. At least part of the heat contained in the compressed air can be removed from the compressed air, so that a particularly high degree of compression of the air can be realized. The heat removed from the compressed air can be stored in the heat accumulator and used for other purposes, for example when driving the expansion apparatus.

In some embodiments, the device comprises a generator which can be driven by the expansion apparatus, by means of which generator electrical energy can be provided by driving the generator. It is thereby, for example, possible in a particularly efficient and effective manner to store electrical energy in a different energy form in the device and to release electrical energy from the device, the device also suitable for particularly high power ranges and for long-term storage. This means that the device allows a low-cost storage of energy, in particular electrical energy, on a large scale and with high degrees of efficiency.

In some embodiments, heat is supplied to the second vessel and thus to the content thereof during the heat supply by means of the temperature-control apparatus and originates for example from a power-plant or industrial process, in particular from a further medium of such a power-plant or industrial process. The heat may be, for example, waste heat, contained in the further medium and, by means of the device, can be used for efficient and effective storage of energy.

In some embodiments, the disclosure teaches methods for storing energy, in particular electrical energy, by means of a device, in particular a device as described above. The device thus comprises at least one first vessel having a first holding space and a separating apparatus arranged in the first vessel, by means of which apparatus the first holding space is divided into a first chamber for holding a first medium and a second chamber for holding a gas phase, the separating apparatus being able to be moved relative to the first vessel with a simultaneous change in volume of the chambers.

In some embodiments, the device also comprises at least one second vessel, which has a second holding space connected to the second chamber, the content of which space undergoes mass transfer (ideally in thermodynamic equilibrium) with the gas phase. Furthermore, a temperature-control apparatus is provided, by means of which heat energy can be supplied to the second vessel and removed from the second vessel.

In some embodiments, the device comprises at least one conveying apparatus, by means of which the medium is conveyed at a specifiable pressure into the first chamber, a removal of heat from the second vessel being simultaneously effected by means of the temperature-control apparatus. Also, at least one expansion apparatus is provided, which is driven by the medium held under pressure in the first chamber, a supply of heat to the second vessel being simultaneously effected by means of the temperature-control apparatus.

In some embodiments, the supply of heat to the second vessel is carried out at a temperature of less than 200 degrees Celsius (° C.), or at less than 140 degrees Celsius, or at less than 100 degrees Celsius. Consequently, the device can be operated at particularly low operating temperatures, and so low-cost standard components can be used. As a result, storage costs for storing the energy can be kept low. It is thereby possible to avoid using particularly temperature-resistant and thus costly materials.

To store the energy in a particularly low-cost manner, during the supply of heat, heat may be transferred from a further medium via the temperature-control apparatus to the second vessel, in particular to the content of said vessel, the further medium having a temperature of less than 200 degrees Celsius, or less than 140 degrees Celsius, or less than 100 degrees Celsius. The vessel, which for example is designed as a pressure vessel, may be filled with cold media having a temperature of less than 140 degrees Celsius, or less than 100 degrees Celsius. This allows the use of particularly low-cost materials and pressure-vessel designs, so that, for example, plastic-based vessels or concrete-based underground vessels can be used as the vessels.

In some embodiments, during the supply of heat, the heat is provided by a power plant, an industrial process or a natural heat source, for example geothermal, and/or solar heat energy. These examples allow a particularly efficient method to be realized.

In some embodiments, the medium is provided directly from a power plant or an industrial process and supplied back to there again.

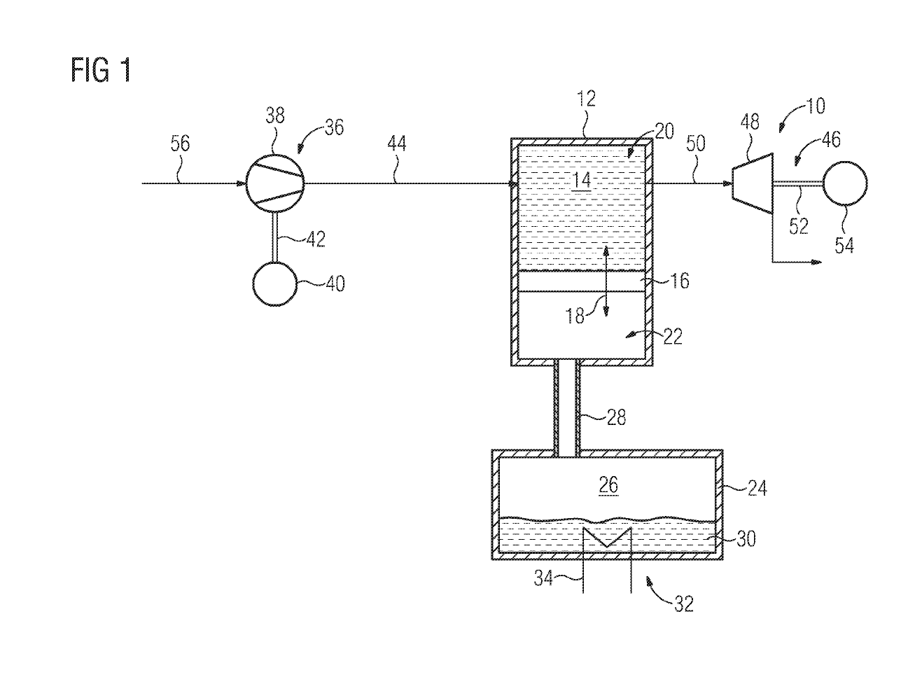

FIG. 1 shows in a diagrammatic illustration a device, which is denoted overall by reference sign 10, according to an example embodiment for storing energy in the form of electrical energy. The device 10 comprises at least one first vessel 12, which has a first holding space which is denoted overall by reference sign 14. The device 10 may comprise a plurality of first vessels with respective first holding spaces. In this case, the several vessels can be arranged in parallel or in series with respect to one another. The first vessel 12 is a first pressure vessel, since a medium under pressure is stored in the first vessel 12, as will be explained below.

The device 10 comprises a separating apparatus 16, which is arranged in the first holding space 14 and can be moved relative to the first vessel 12. As indicated by a double arrow 18 in FIG. 1, the separating apparatus 16 can be moved in a translatory manner, that is to say can be displaced, relative to the first vessel 12.

The first holding space 14 is divided by means of the separating apparatus 16 into a first chamber 20 and into a second chamber 22. The abovementioned medium is or can be held in the first chamber 20, the medium in the first embodiment being a liquid, for example in the form of liquid water. A gas phase is held in the second chamber 22 opposite the first chamber 20. This means that, on a first side of the separating apparatus 16, the medium is present in the form of liquid water, and on a second side, which is opposite to the first side, of the separating apparatus 16, a gas phase is present. The separating apparatus 16 can be displaced or moved easily, and so the same pressure prevails on both sides, that is to say in the two chambers 20 and 22. The chambers 20 and 22 are preferably separated or sealed off from one another by means of the separating apparatus 16, and so a mass transfer between the chambers 20 and 22 is not possible or is possible only to a very small degree.

The separating apparatus 16 can be formed in different ways. The use of a displaceable surface as a piston is possible, for example, as indicated in FIG. 1. In other words, it is possible for the separating apparatus 16 to be a piston, which can be displaced relative to the first vessel 12. Alternatively, the separating apparatus 16 can be a designed as an elastic bladder, e.g., an elastic polymer bladder, which expands or inflates in a manner similar to an air balloon when a volume, in particular a gas volume, increases in the interior thereof. In this embodiment, it is then for example also the case that no sealing surface exists, and particularly good leak-tightness between the medium, or the water, and the gas phase can be realized. Alternatively, the use of a non-elastic or rigid material is possible. In this case, a structure of the non-elastic material, for example, is then inserted in the first vessel 12, and this structure can for example fold together when the water is conveyed or pumped into the first vessel 12, in particular the first chamber 20.

FIG. 1 shows the separating apparatus 16 is able to be moved or displaced relative the first vessel 12 with a simultaneous change in volume of the chambers 20 and 22. This means that a displacement of the separating apparatus 16 relative to the first vessel 12 is for example accompanied by a decrease in volume of the first chamber 20 and simultaneously an increase in volume of the second chamber 22. Here, the volume of the first chamber 20 is decreased to the same degree as that to which the volume of the second chamber 22 is increased, and vice versa.

The device 10 further comprises at least one second vessel 24, which is likewise comprises a pressure vessel. The second vessel 24 has a second holding space 26 fluidically connected to the second chamber 22 via at least one line 28. Here, a content 30 of the holding space 26 undergoes mass transfer, in particular ideally in thermodynamic equilibrium at all times, with the gas phase present in the second chamber 22. The content 30 can be a liquid or a solid which is in thermodynamic equilibrium with the gas phase in the second chamber 22. The liquid can be the same substance or the same substance mixture as the gas phase, for example a thermodynamic phase equilibrium in the two-phase region. Furthermore, a solution equilibrium between the content 30, in the form of a liquid, and the gas phase is possible, or there exists a chemical reaction in equilibrium between the gas phase and the content 30.

The device 10 moreover comprises a temperature-control apparatus 32, by means of which heat energy can be supplied to the second vessel 24 and thus to the content 30 thereof and can be removed from the second vessel 24 or from the content 30 thereof. In other words, the temperature-control apparatus 32 is an apparatus for supplying heat to the second vessel 24 and for removing heat from the second vessel 24. To realize this supply of heat and the removal of heat, the temperature-control apparatus 32 comprises, for example, a heat transfer device 34, which is also referred to as a heat exchanger.

Furthermore, the device may comprise at least one conveying apparatus 36 having a pump 38, by means of which apparatus the medium, in the form of water, can be conveyed at a specifiable pressure into the first chamber 20. In this case, a motor in the form of an electric motor 40 is assigned to the pump 38, the rotor of which motor is connected to the pump 38 via a shaft 42. As a result, the pump 38 can be driven by means of the electric motor 40. To convey the water, the electric motor 40 is supplied with energy in the form of electrical energy or electricity, and so electricity is expended to convey the water into the first chamber 20. Here, the conveying apparatus 36, in particular the pump 38, is fluidically connected to the first chamber 14 via at least one line 44, such that the water can be conveyed by means of the pump 38 into the first chamber 20 via the line 44.

The device 10 may also comprise at least one expansion apparatus having a turbine 48 or another engine. The turbine 48 is arranged in a line 50 that is fluidically connected to both the turbine 48 and the first chamber 20. The water that is stored under pressure in the first chamber 20 can be removed from the first chamber 20 via the line 50 and supplied to the turbine 48, such that the turbine 48 can be driven or is driven by the medium (water) held under pressure in the first chamber 20.

The driving of the turbine 48 results in this providing mechanical energy. Here, the turbine 48 is coupled to a shaft 52 via which the mechanical energy can be provided. The device 10 also comprises here an electric machine in the form of a generator 54, which is coupled to the shaft 52 and can thereby be driven by the turbine 48 or by the mechanical power provided by the turbine 48. By means of the generator 54, it is therefore possible for at least part of the mechanical energy provided by the turbine 48 via the shaft 52 to be converted into electrical energy or electricity.

If, for example, heat at a high temperature level is supplied to the second vessel 24 or to the content 30 thereof, the pressure in the second vessel 24 or in the second holding space 26 increases due to the influence of the equilibrium position. For example—if the content 30 is a pure substance, e.g., ammonia—an evaporation of the pure substance occurs, and the pressure increases in line with the vapor pressure curve of the pure substance. By means of a supply of heat to the second vessel 24 or a removal of heat from the second vessel 24, it is therefore possible to influence the pressure in the two vessels 12 and 24, since the holding space 26 communicates with the second chamber 22 via the line 28.

In order now, by means of the device 10, to store or temporarily store energy in the form of electrical energy and thus to accumulate said energy in the device 10, water is pumped into the first chamber 20 by means of the pump 38. This results in a displacement of the separating apparatus 16 in such a manner that the volume of the first chamber 20 increases and simultaneously the volume of the second chamber 22 decreases. Simultaneously, while the water is being conveyed into the first chamber 20 by means of the pump 38, heat at an at least substantially constant temperature is removed from the second vessel 24 via the heat transfer device 34, which results in a condensation of the gas phase and a decrease in the volume thereof. The pumping-in of the water and the simultaneous removal of heat from the second vessel 24 lead to the first vessel 12 filling with water and the pressure in the first vessel 12 remaining at least substantially the same. In this case, the pump 38 conveys against a constant counter-pressure, which allows a design that is at least substantially optimal and a high degree of efficiency.

A first design calculation was carried out with ammonia as the liquid or the medium. In this case, according to the vapor pressure curve of ammonia, water at approximately 10 bar can be pumped into the first vessel 12 if heat at approximately 25 degrees Celsius is removed at the heat exchanger 34 or by means of this from the second vessel 24. If the first vessel 12 is now filled with water, the accumulation process is complete and the system or the device 10 is completely charged.

If it is now sought to recover electrical energy or electricity again, heat is supplied at a high temperature of less than 200 degrees Celsius (° C.), at less than 140 degrees Celsius (° C.), or of less than 100 degrees Celsius (° C.), to the heat transfer device 34. This takes place for example by a further medium being supplied to the heat transfer device 34, the temperature of which medium is less than 200 degrees Celsius, less than 140 degrees Celsius, or less than 100 degrees Celsius. The further medium originates for example from a power-plant or industrial process and contains heat in the form of waste heat, which can be used via the heat transfer device 34 or the temperature-control apparatus 32 when recovering electricity, that is to say when releasing energy. This heat supply causes the pressure in the two vessels 12 and 24 to increase.

In the example with ammonia as the medium, an inner pressure of approximately 33 bar is obtained for a supply of heat at 70 degrees Celsius. In this case, the water is now available at an elevated pressure for the expansion via the turbine 48 designed as an expansion machine. On account of the elevated pressure during the release of energy, it is even possible for a higher amount of electrical energy to be released than was previously accumulated via the electric motor 40. Assuming isotropic degrees of efficiency of the pump 38 and of the turbine 48 of 90 percent, assuming water as the conveyable medium into the chamber 20 and assuming that ammonia is used as the medium or the liquid which is evaporated or condensed, the factor between released electrical energy and accumulated electrical energy is approximately 1.7, which corresponds to a degree of electrical storage efficiency of up to 170 percent.

The supply of heat during the release of energy is possible from a plurality of sources. In other words, a plurality of sources can be used which provide waste heat which can be supplied to the second vessel 24 via the heat transfer device 34. For this purpose, for example, heat from the waste gas or the water vapor circuit of power plants and industrial installations, from geothermal heat, from solar heat, from heat from heating networks, from combustion heat or from other sources can be used. The incorporation or introduction or supply of heat to the second vessel 24 is possible by means of a plurality of solutions. Here, for example, heat exchanger surfaces, ribbed tubes, heat tubes, so-called heat pipes, etc. can be used.

Overall, in the first embodiment, energy storage through pressurized water in the at least one vessel 12 designed as a pressure vessel takes place by means of the device 10. In this case, during the energy release process, waste heat at a temperature level of less 200 degrees Celsius (° C.) is used. Waste heat in the temperature range of less than 200 degrees Celsius, less than 100 degrees Celsius, is produced during many power-plant and industrial processes. This temperature level is usually too low to make use of the heat possible. Also, in some processes, a targeted removal of heat in this temperature range is necessary, since, for example, a process stream is to be cooled. Generally, exhaust heat of less than 100 degrees Celsius is available at various locations and can thus be deployed or used at a low cost or at no cost.

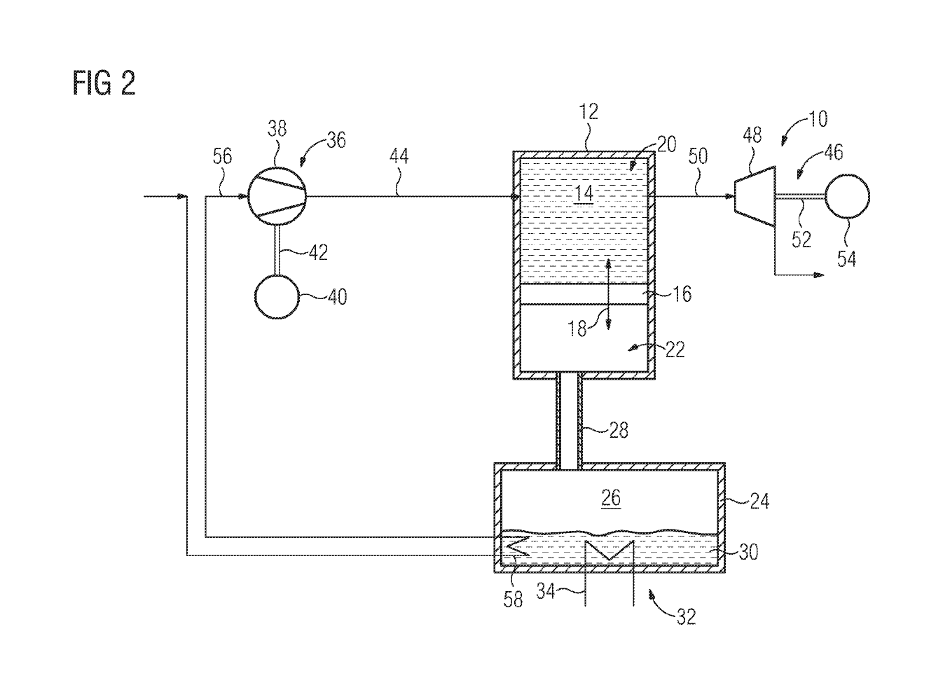

FIG. 2 shows a second example embodiment of the device 10. In the first embodiment and in the second embodiment, a line 56 that can be flowed through by the medium is provided, for example upstream of the pump 38 in the flow direction of the medium, via which line the medium is supplied, for example, from a reservoir to the pump 38. The second embodiment differs now from the first embodiment at least in that a further heat transfer device 58 is arranged in the line 56 and is thus arranged upstream of the first chamber 20 and, in the present case, upstream of the pump 38 in the flow direction of the medium. The further heat transfer device 58 serves for effecting a heat exchange between the medium flowing through the line 56 and the content 30 of the second vessel 24.

The second embodiment may be used if cold water is the medium. This water can then be used for the purpose of heat exchange with the content 30, which content may be formed as a liquid or a solid. It is possible to cool the content 30 as a result of a heat transfer from the content 30 via the heat exchanger 58 to the medium flowing through the heat exchanger 58, so that the temperature of the content 30 and thus the pressure in the system can be kept low. Consequently, the electrical energy input for the filling of the first vessel 12, the first chamber 20, with water can also be kept particularly low.

During the accumulation of energy, it is also possible to use warm or hot water as the medium. As a result, a combination of heat and electricity storage, for example, is possible. Prior to accumulation, the warm water deployed can absorb heat from a heat source. The storage of large quantities of warm water, the temperature of which is less than 140 degrees Celsius, is currently carried out in district heating accumulators. These heat accumulators serve for example as buffers in district heating networks. This can also be carried out in the case of the device 10. For this purpose, following its expansion, the warm water is supplied to a heat exchanger, so that heat contained in the water can be extracted from the water and used.

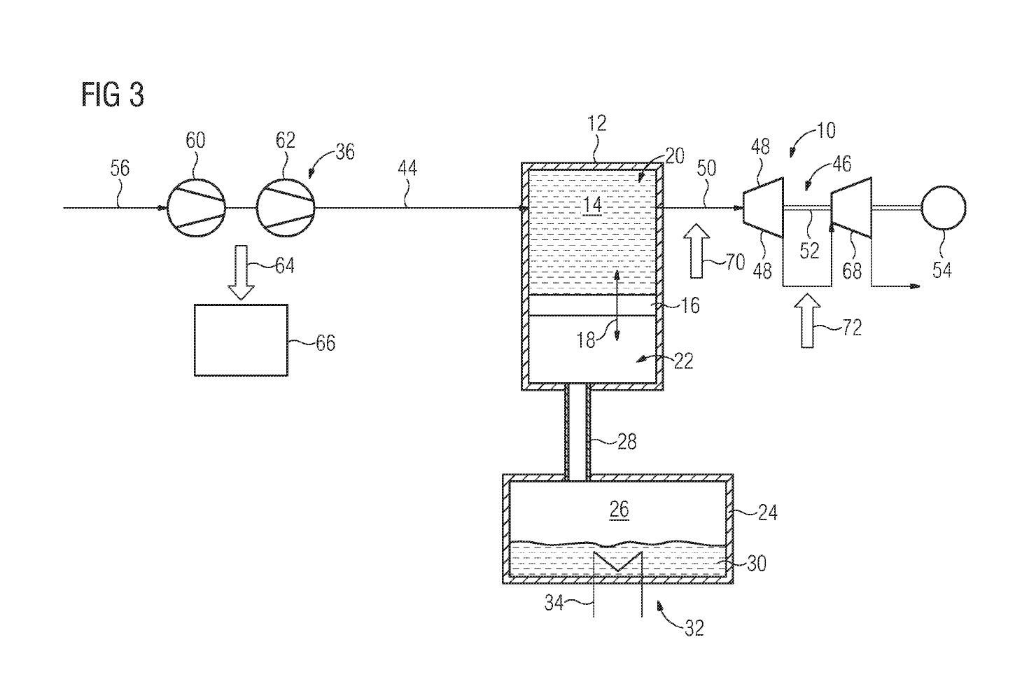

FIG. 3 shows the device 10 according to a third example embodiment. In the third embodiment, no liquid but instead a gas in the form of air is used as the medium. The medium is a storage medium which is used for the accumulation and release of the electrical energy.

In the third embodiment, the conveying apparatus 36 comprises two compressors 60 and 62 arranged in series or serially with respect to one another and by means of which the air is conveyed and compressed. By way of example, an electric motor is assigned to each of the compressors 60 and 62, by means of which motor the respective compressor 60 or 62 can be driven with the expenditure of electrical energy or electricity. It is thus also possible, in the case of the third embodiment, to accumulate or to temporarily store electrical energy in the device 10 and to release energy from this.

Compression of the air causes this to heat up. Between the compressors 60 and 62, which are also referred to as stages or compression stages, a cooling apparatus (not illustrated in FIG. 3) is provided, by means of which the air compressed and thereby heated by the compressor 60 is cooled downstream of the compressor 60 and upstream of the compressor 62. As a result of this cooling, at least part of a quantity of heat contained in the air is removed from the air, this being indicated by a directional arrow 64 in FIG. 3. The heat removed from the air by means of the cooling device is supplied to a heat accumulator 66 and stored therein. Overall, it is noticeable from FIG. 3 that a multi-stage compression of the air is provided in the third embodiment. Here, heat is removed from the compressed air, in each case between the stages (compressors 60 and 62), and so the air is cooled. The heat may be removed at a temperature level of less than 200 degrees Celsius. The storage of the removed heat in the heat accumulator 66 allows the stored heat to be used for other purposes, as will be explained below.

In the third embodiment, the expansion of air during the release of energy also may be carried out in a multi-stage manner. For this purpose, the expansion apparatus 46 comprises the turbine 48 and a further turbine 68 that is arranged in series with respect to the turbine 48. Here, the turbines 48 and 68 are coupled to one another via the shaft 52, such that the generator 54 can be driven by the turbines 48 and 68. A directional arrow 70 indicates that at least part of the heat stored in the heat accumulator 66 is supplied to the air downstream of the first vessel 12 and upstream of the turbine 48. Also—as indicated by a directional arrow 72—at least part of the heat stored in the heat accumulator 66 is supplied to the air between the turbines 48 and 68, in order thereby to increase the production of electricity during the release of energy and to avoid an excessive drop in the temperature of the air during the expansion. Due to the use of waste heat during the release of energy, the degree of electrical storage efficiency is very high in comparison to conventional pressurized-air designs and can lie within a range of 70 percent inclusive to 80 percent inclusive. The supply of heat, which is indicated by the directional arrow 72, can also occur by means of combustion of a renewable or fossil fuel, such as natural gas.

Overall, it is noticeable from FIGS. 1 to 3 that by using waste heat, a pressure increase in a pressurized-water or pressurized-air accumulator in the form of the first vessel 12 is realized. Here, a supply of heat in a temperature range of less than 200 degrees Celsius (° C.), less than 140 degrees Celsius, or less than 100 degrees Celsius is used in order, in a system comprising a gas phase and a liquid or solid phase (for example two-phase region of a pure substance or of a substance mixture, solution equilibrium of a gas and a liquid, chemical reaction between a gas and a liquid or solid), to effect an increase in pressure and to transfer this to the storage medium in the form of water or air.

The accumulation of energy takes place against a constant storage pressure, so that operation of the pump 38 or of the compressors 60 and 62, that is to say of the conveying apparatus 36, that is at least substantially optimal is possible at all times. The release of energy likewise takes place at constant pressure from the pressure vessel in the form of the first vessel 12, which permits a high degree of efficiency of electricity production due to the at least substantially optimal design of an engine for this pressure. The system may be operated at low operating temperatures of less than 200 degrees Celsius in the case of air and in the case of water, in order to make it possible to use low-cost standard components. Low storage costs can consequently be realized. Also the pressure vessels in the form of vessels 12 and 24 are filled only with relatively cold media with a temperature of less than 200 degrees Celsius, less than 140 degrees Celsius, or less than 100 degrees Celsius, so that low-cost materials and pressure vessel designs can be used.

What is claimed is:

1. A device for storing energy, the device comprising:
a first vessel having a first holding space;
a separating apparatus arranged in the first vessel dividing the first holding space into a first chamber for holding a first medium and a second chamber for holding a gas phase; the separating apparatus movable relative to the first vessel causing a simultaneous change in volume of the first chamber and the second chamber;
a second vessel with a second holding space connected to the second chamber, content of the second holding space exchanging mass transfer of the gas phase in the second chamber;
a temperature-control apparatus supplying heat energy to the second vessel and removing heat energy from the second vessel;
a conveying apparatus conveying the medium at a specifiable pressure into the first chamber with a simultaneous removal of heat from the second vessel effected by means of the temperature-control apparatus; and
an expansion apparatus driven by the medium held under pressure in the first chamber with a simultaneous supply of heat to the second vessel effected by means of the temperature-control apparatus.

2. The device as claimed in claim 1, further comprising a heat transfer device arranged upstream of the first chamber for effecting a heat transfer between the medium and the content of the second vessel.

3. The device as claimed in claim 1, wherein the medium comprises a liquid or a gas.

4. The device as claimed in claim 1, wherein the content of the second vessel is a liquid or a solid.

5. The device as claimed in claim 1, wherein the conveying apparatus comprises a compressor for compressing the medium.

6. The device as claimed in claim 5, further comprising a heat accumulator, in which heat from the medium heated by means of the compression can be stored.

7. The device as claimed in claim 1, further comprising a generator driven by the expansion apparatus, to provide electrical energy.

8. A method for storing energy by means of a device comprising
a first vessel having a first holding space,
a separating apparatus arranged in the first vessel dividing the first holding space into a first chamber for holding a
first medium and a second chamber for holding a gas phase, the separating apparatus movable relative to the first vessel with a simultaneous change in volume of the chambers, a
second vessel with a second holding space connected to the second chamber, the content of the second holding space exchanging mass transfer with the gas phase in the second chamber,
a temperature-control apparatus supplying heat energy to the second vessel and removing heat energy from the second vessel, a
conveying apparatus conveying the medium at a specifiable pressure into the first chamber, and an
expansion apparatus driven by the medium held under pressure in the first chamber, the method comprising:
conveying the medium at a specifiable pressure into the first chamber and simultaneously removing heat from the second vessel using the temperature-control apparatus; and
driving the expansion apparatus with the medium held under pressure in the first chamber and simultaneously supplying heat to the second vessel using the temperature-control apparatus.

9. The method as claimed in claim 8, wherein the supply of heat to the second vessel is carried out at a temperature of less than 200 degrees Celsius, in particular at less than 140 degrees Celsius, and/or less than 100 degrees Celsius.

10. The method as claimed in claim 9, wherein, during the supply of heat, heat is transferred from a further medium into the second vessel via the temperature-control apparatus, the further medium having a temperature of less than 200 degrees Celsius, less than 140 degrees Celsius, and/or less than 100 degrees Celsius.

11. The method as claimed in claim 8, wherein, during the supply of heat, the heat is provided by a power plant, an industrial process or a natural heat source.

12. The method as claimed in claim 8, wherein the medium is provided directly from a power plant or an industrial process and supplied back to there again.
